(19) United States
(12) Patent Application Publication
(10) Pub. No.: US 2026/0304535 A1
(43) Pub. Date: Oct. 1, 2026

(54) METHOD AND APPARATUS FOR PERFORMING WIRELESS COMMUNICATION HAVING IMPROVED WIRELESS CONNECTIVITY

(71) Applicant: KT CORPORATION, Gyeonggi-do (KR)

(72) Inventors: Kyu Jin PARK, Gyeonggi-do (KR); Sung Kwan KIM, Gyeonggi-do (KR)

(73) Assignee: KT CORPORATION, Gyeonggi-do (KR)

(21) Appl. No.: 19/483,213

(22) PCT Filed: May 9, 2024
(86) PCT No.: PCT/KR2024/006274

§ 371 Date: Nov. 10, 2025

(30) Foreign Application Priority Data
May 10, 2023 (KR) 10-2023-0060740

(51) Int. Cl. H04W 76/20; H04W 88/04

(52) U.S. Cl. CPC H04W 76/20; H04W 88/04

(57) ABSTRACT

Provided are a method and an apparatus for performing wireless communication having improved wireless connectivity. The method may include receiving information on an auxiliary device set composed of at least one auxiliary device selected from an auxiliary device pool, receiving information on an auxiliary mode selected from among a plurality of auxiliary modes using the auxiliary device set for wireless communication with a base station, and performing wireless communication through at least one of a wireless link with the base station and a wireless link with the auxiliary device set on the basis of the information on the selected auxiliary mode.

### TECHNICAL FIELD

The disclosure relates to a method and device for performing wireless communication having enhanced wireless connectivity in a next-generation radio access network (hereinafter, “new radio (NR)”).

### BACKGROUND ART

Recently, the 3rd generation partnership project (3GPP) has approved the “Study on New Radio Access Technology”, which is a study item for research on next-generation/5G radio access technology (hereinafter, referred to as “new radio” or “NR”). On the basis of the Study on New Radio Access Technology, Radio Access Network Working Group 1 (RAN WG1) has been discussing frame structures, channel coding and modulation, waveforms, multiple access methods, and the like for the new radio (NR). It is required to design the NR not only to provide an improved data transmission rate as compared with the long term evolution (LTE)/LTE-Advanced, but also to meet various requirements in detailed and specific usage scenarios.

An enhanced mobile broadband (eMBB), massive machine-type communication (mMTC), and ultra reliable and low latency communication (URLLC) are proposed as representative usage scenarios of the NR. In order to meet the requirements of the individual scenarios, it is required to design the NR to have flexible frame structures, compared with the LTE/LTE-Advanced.

Because the requirements for data rates, latency, reliability, coverage, etc. are different from each other, there is a need for a method for efficiently multiplexing a radio resource unit based on different numerologies from other (e.g., subcarrier spacing, subframe, Transmission Time Interval (TTI), etc.) as a method for efficiently satisfying each usage scenario requirement through a frequency band constituting any NR system.

As a portion of this aspect, recently newly introduced various types of wireless devices or existing automobile or home appliances require wireless connectivity functionality to provide diverse services, and accordingly a design capable of providing enhanced wireless connectivity is needed.

### DETAILED DESCRIPTION OF THE INVENTION

### Technical Problem

The disclosure may provide a method and device for performing wireless communication with enhanced wireless connectivity.

### Technical Solution

In accordance with an embodiment, the disclosure provides a method for a UE to perform wireless communication. The method may include receiving information about an assistance device set including at least one assistance device selected from within an assistance device pool, receiving information about an assistance mode selected from among a plurality of assistance modes utilizing the assistance device set for wireless communication with a base station, and performing wireless communication through at least one of a wireless link with the base station or a wireless link with the assistance device set based on the information about the selected assistance mode.

In accordance with another embodiment, the disclosure provides a method for a base station to perform wireless communication. The method may include transmitting information about an assistance device set including at least one assistance device selected from within an assistance device pool, transmitting information about an assistance mode selected from among a plurality of assistance modes utilizing the assistance device set for wireless communication with a UE, and performing wireless communication through at least one of a wireless link with the UE or a wireless link with the assistance device set based on the information about the selected assistance mode.

In accordance with yet another embodiment, the disclosure provides a UE performing wireless communication. The UE may include a transmitter, a receiver, and a controller controlling an operation of the transmitter and the receiver, wherein the controller is configured to receive information about an assistance device set including at least one assistance device selected from within an assistance device pool, receive information about an assistance mode selected from among a plurality of assistance modes utilizing the assistance device set for wireless communication with a base station, and perform wireless communication through at least one of a wireless link with the base station or a wireless link with the assistance device set based on the information about the selected assistance mode.

In accordance with still another embodiment, the disclosure provides a base station performing wireless communication. The base station may include a transmitter, a receiver, and a controller controlling an operation of the transmitter and the receiver, wherein the controller is configured to transmit information about an assistance device set including at least one assistance device selected from within an assistance device pool, transmit information about an assistance mode selected from among a plurality of assistance modes utilizing the assistance device set for wireless communication with a UE, and perform wireless communication through at least one of a wireless link with the UE or a wireless link with the assistance device set based on the information about the selected assistance mode.

### Advantageous Effects

According to the embodiments, wireless communication may be performed between a UE and a base station with enhanced wireless connectivity.

### BRIEF DESCRIPTION OF DRAWINGS

FIG. 1 is a view schematically illustrating an NR wireless communication system in accordance with embodiments of the present disclosure.

FIG. 2 is a view schematically illustrating a frame structure in an NR system in accordance with embodiments of the present disclosure.

FIG. 3 is a view for explaining resource grids supported by a radio access technology in accordance with embodiments of the present disclosure.

FIG. 4 is a view for explaining bandwidth parts supported by a radio access technology in accordance with embodiments of the present disclosure.

FIG. 5 is a view illustrating an example of a synchronization signal block in a radio access technology in accordance with embodiments of the present disclosure.

FIG. 6 is a signal diagram for explaining a random access procedure in a radio access technology in accordance with embodiments of the present disclosure.

FIG. 7 is a view for explaining CORESET.

FIG. 8 is a view illustrating an example of a symbol level alignment among different SCSs to which the present embodiments may apply.

FIG. 9 is a view illustrating a conceptual example for a bandwidth part to which the present embodiments may apply.

FIG. 10 is a flowchart illustrating a procedure for a UE to perform wireless communication with enhanced wireless connectivity according to an embodiment.

FIG. 11 is a flowchart illustrating a procedure for a base station to perform wireless communication with enhanced wireless connectivity according to an embodiment.

FIG. 12 is a view illustrating a first assistance mode utilizing only a wireless link with an assistance device set according to the present embodiment.

FIGS. 13 to 15 are views illustrating a second assistance mode utilizing both a wireless link between a UE and a base station and a wireless link with an assistance device set according to the present embodiment.

FIG. 16 is a block diagram illustrating a UE according to an embodiment.

FIG. 17 is a block diagram illustrating a base station according to an embodiment.

### MODE FOR CARRYING OUT THE INVENTION

Hereinafter, some embodiments of the present disclosure will be described in detail with reference to the accompanying illustrative drawings. In the drawings, like reference numerals are used to denote like elements throughout the drawings, even if they are shown on different drawings. Further, in the following description of the present disclosure, a detailed description of known functions and configurations incorporated herein will be omitted when it may make the subject matter of the present disclosure rather unclear. When the expression “include”, “have”, “comprise”, or the like as mentioned herein is used, any other part may be added unless the expression “only” is used. When an element is expressed in the singular, the element may cover the plural form unless a special mention is explicitly made of the element.

In addition, terms, such as first, second, A, B, (A), (B) or the like may be used herein when describing components of the present disclosure. Each of these terminologies is not used to define an essence, order or sequence of a corresponding component but used merely to distinguish the corresponding component from other component(s).

In describing the positional relationship between components, if two or more components are described as being “connected”, “combined”, or “coupled” to each other, it should be understood that two or more components may be directly “connected”, “combined”, or “coupled” to each other, and that two or more components may be “connected”, “combined”, or “coupled” to each other with another component “interposed” therebetween. In this case, another component may be included in at least one of the two or more components that are “connected”, “combined”, or “coupled” to each other.

In the description of a sequence of operating methods or manufacturing methods, for example, the expressions using “after”, “subsequent to”, “next”, “before”, and the like may also encompass the case in which operations or processes are performed discontinuously unless “immediately” or “directly” is used in the expression.

Numerical values for components or information corresponding thereto (e.g., levels or the like), which are mentioned herein, may be interpreted as including an error range caused by various factors (e.g., process factors, internal or external impacts, noise, etc.) even if an explicit description thereof is not provided.

The wireless communication system in the present specification refers to a system for providing various communication services, such as a voice service and a data service, using radio resources. The wireless communication system may include a user equipment (UE), a base station, a core network, and the like.

Embodiments disclosed below may be applied to a wireless communication system using various radio access technologies. For example, the embodiments may be applied to various radio access technologies such as code division multiple access (CDMA), frequency division multiple access (FDMA), time division multiple access (TDMA), orthogonal frequency division multiple access (OFDMA), single-carrier frequency division multiple access (SC-FDMA), non-orthogonal multiple access (NOMA), or the like. In addition, the radio access technology may refer to respective generation communication technologies established by various communication organizations, such as 3GPP, 3GPP2, Wi-Fi, Bluetooth, IEEE, ITU, or the like, as well as a specific access technology. For example, CDMA may be implemented as a wireless technology such as universal terrestrial radio access (UTRA) or CDMA2000. TDMA may be implemented as a wireless technology such as global system for mobile communications (GSM)/general packet radio service (GPRS)/enhanced data rates for GSM evolution (EDGE). OFDMA may be implemented as a wireless technology such as IEEE (Institute of Electrical and Electronics Engineers) 802.11 (Wi-Fi), IEEE 802.16 (WiMAX), IEEE 802-20, evolved UTRA (E-UTRA), and the like. IEEE 802.16m is evolution of IEEE 802.16e, which provides backward compatibility with systems based on IEEE 802.16e. UTRA is a part of a universal mobile telecommunications system (UMTS). 3GPP (3rd-generation partnership project) LTE (long-term evolution) is a part of E-UMTS (evolved UMTS) using evolved-UMTS terrestrial radio access (E-UTRA), which adopts OFDMA in a downlink and SC-FDMA in an uplink. As described above, the embodiments may be applied to radio access technologies that have been launched or commercialized, and may be applied to radio access technologies that are being developed or will be developed in the future.

The UE used in the specification must be interpreted as a broad meaning that indicates a device including a wireless communication module that communicates with a base station in a wireless communication system. For example, the UE includes user equipment (UE) in WCDMA, LTE, NR, HSPA, IMT-2020 (5G or New Radio), and the like, a mobile station in GSM, a user terminal (UT), a subscriber station (SS), a wireless device, and the like. In addition, the UE may be a portable user device, such as a smart phone, or may be a vehicle, a device including a wireless communication module in the vehicle, and the like in a V2X communication system according to the usage type thereof. In the case of a machine-type communication (MTC) system, the UE may refer to an MTC terminal, an M2M terminal, or a URLLC terminal, which employs a communication module capable of performing machine-type communication.

A base station or a cell in the present specification refers to an end that communicates with a UE through a network and encompasses various coverage regions such as a Node-B, an evolved Node-B (eNB), a gNode-B, a low-power node (LPN), a sector, a site, various types of antennas, a base transceiver system (BTS), an access point, a point (e.g., a transmission point, a reception point, or a transmission/reception point), a relay node, a megacell, a macrocell, a microcell, a picocell, a femtocell, a remote radio head (RRH), a radio unit (RU), a small cell, and the like. In addition, the cell may be used as a meaning including a bandwidth part (BWP) in the frequency domain. For example, the serving cell may refer to an active BWP of a UE.

The various cells listed above are provided with a base station controlling one or more cells, and the base station may be interpreted as two meanings. The base station may be 1) a device for providing a megacell, a macrocell, a microcell, a picocell, a femtocell, or a small cell in connection with a wireless region, or the base station may be 2) a wireless region itself. In the above description 1), the base station may be the devices controlled by the same entity and providing predetermined wireless regions or all devices interacting with each other and cooperatively configuring a wireless region. For example, the base station may be a point, a transmission/reception point, a transmission point, a reception point, and the like according to the configuration method of the wireless region. In the above description 2), the base station may be the wireless region in which a user equipment (UE) may be enabled to transmit data to and receive data from the other UE or a neighboring base station.

In this specification, the cell may refer to coverage of a signal transmitted from a transmission/reception point, a component carrier having coverage of a signal transmitted from a transmission/reception point (or a transmission point), or a transmission/reception point itself.

An uplink (UL) refers to a scheme of transmitting data from a UE to a base station, and a downlink (DL) refers to a scheme of transmitting data from a base station to a UE. The downlink may mean communication or communication paths from multiple transmission/reception points to a UE, and the uplink may mean communication or communication paths from a UE to multiple transmission/reception points. In the downlink, a transmitter may be a part of the multiple transmission/reception points, and a receiver may be a part of the UE. In addition, in the uplink, the transmitter may be a part of the UE, and the receiver may be a part of the multiple transmission/reception points.

The uplink and downlink transmit and receive control information over a control channel, such as a physical downlink control channel (PDCCH) and a physical uplink control channel (PUCCH). The uplink and downlink transmit and receive data over a data channel such as a physical downlink shared channel (PDSCH) and a physical uplink shared channel (PUSCH).

Hereinafter, the transmission and reception of a signal over a channel, such as PUCCH, PUSCH, PDCCH, PDSCH, or the like, may be expressed as “PUCCH, PUSCH, PDCCH, PDSCH, or the like is transmitted and received”.

For the sake of clarity, the following description will focus on 3GPP LTE/LTE-A/NR (New Radio) communication systems, but technical features of the disclosure are not limited to the corresponding communication systems.

The 3GPP has been developing a 5G (5th-Generation) communication technology in order to meet the requirements of a next-generation radio access technology of ITU-R after studying 4G (4th-generation) communication technology. Specifically, 3GPP is developing, as a 5G communication technology, LTE-A pro by improving the LTE-Advanced technology so as to conform to the requirements of ITU-R and a new NR communication technology that is totally different from 4G communication technology. LTE-A pro and NR all refer to the 5G communication technology. Hereinafter, the 5G communication technology will be described on the basis of NR unless a specific communication technology is specified.

Various operating scenarios have been defined in NR in consideration of satellites, automobiles, new verticals, and the like in the typical 4G LTE scenarios so as to support an enhanced mobile broadband (eMBB) scenario in terms of services, a massive machine-type communication (mMTC) scenario in which UEs spread over a broad region at a high UE density, thereby requiring low data rates and asynchronous connections, and an ultra-reliability and low-latency (URLLC) scenario that requires high responsiveness and reliability and supports high-speed mobility.

In order to satisfy such scenarios, NR introduces a wireless communication system employing a new waveform and frame structure technology, a low-latency technology, a super-high frequency band (mmWave) support technology, and a forward compatible provision technology. In particular, the NR system has various technological changes in terms of flexibility in order to provide forward compatibility. The primary technical features of NR will be described below with reference to the drawings.

### <Overview of NR System>

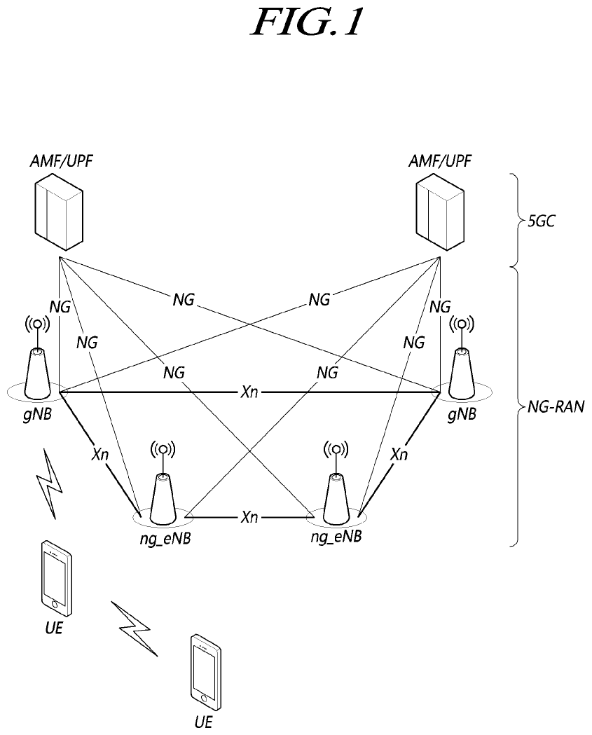

FIG. 1 is a view schematically illustrating an NR system to which the present embodiment is applicable.

Referring to FIG. 1, the NR system is divided into a 5G core network (5GC) and an NG-RAN part. The NG-RAN includes gNBs and ng-eNBs providing user plane (SDAP/PDCP/RLC/MAC/PHY) and user equipment (UE) control plane (RRC) protocol ends. The gNBs or the gNB and the ng-eNB are connected to each other through Xn interfaces. The gNB and the ng-eNB are connected to the 5GC through NG interfaces, respectively. The 5GC may be configured to include an access and mobility management function (AMF) for managing a control plane, such as a UE connection and mobility control function, and a user plane function (UPF) controlling user data. NR supports both frequency bands below 6 GHz (frequency range 1 FR1) and frequency bands equal to or greater than 6 GHz (frequency range 2 FR2).

The gNB denotes a base station that provides a UE with an NR user plane and control plane protocol end. The ng-eNB denotes a base station that provides a UE with an E-UTRA user plane and control plane protocol end. The base station described in the present specification should be understood as encompassing the gNB and the ng-eNB. However, the base station may be also used to refer to the gNB or the ng-eNB separately from each other, as necessary.

### <NR Waveform, Numerology, and Frame Structure>

NR uses a CP-OFDM waveform using a cyclic prefix for downlink transmission and uses CP-OFDM or DFT-s-OFDM for uplink transmission. OFDM technology is easy to combine with a multiple-input multiple-output (MIMO) scheme and allows a low-complexity receiver to be used with high frequency efficiency.

Since the three scenarios described above have different requirements for data rates, delay rates, coverage, and the like from each other in NR, it is necessary to efficiently satisfy the requirements for each scenario over frequency bands constituting the NR system. To this end, a technique for efficiently multiplexing radio resources based on a plurality of different numerologies has been proposed.

Specifically, the NR transmission numerology is determined on the basis of subcarrier spacing and a cyclic prefix (CP). As shown in Table 1 below, “μ” is used as an exponential value of 2 so as to be changed exponentially on the basis of 15 kHz.

TABLE 1

| | Subcarrier | Cyclic | Supported | Supported |
|---|---|---|---|---|
| μ | spacing | prefix | for data | for synch |
| 0 | 15 | normal | Yes | Yes |
| 1 | 30 | normal | Yes | Yes |
| 2 | 60 | Normal, | Yes | No |
| | | Extended | | |
| 3 | 120 | normal | Yes | Yes |
| 4 | 240 | normal | No | Yes |

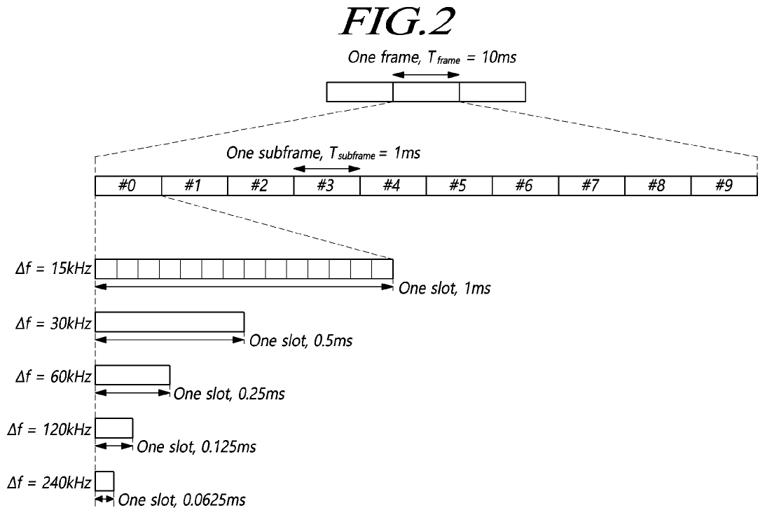

As shown in Table 1 above, NR may have five types of numerologies according to subcarrier spacing. This is different from LTE, which is one of the 4G-communication technologies, in which the subcarrier spacing is fixed to 15 kHz. Specifically, in NR, subcarrier spacing used for data transmission is 15, 30, 60, or 120 kHz, and subcarrier spacing used for synchronization signal transmission is 15, 30, 120, or 240 kHz. In addition, an extended CP is applied only to the subcarrier spacing of 60 kHz. A frame that includes 10 subframes each having the same length of 1 ms and has a length of 10 ms is defined in the frame structure in NR. One frame may be divided into half frames of 5 ms, and each half frame includes 5 subframes. In the case of a subcarrier spacing of 15 kHz, one subframe includes one slot, and each slot includes 14 OFDM symbols. FIG. 2 is a view for explaining a frame structure in an NR system to which the present embodiment may be applied. Referring to FIG. 2, a slot includes 14 OFDM symbols, which are fixed, in the case of a normal CP, but the length of the slot in the time domain may be varied depending on subcarrier spacing. For example, in the case of a numerology having a subcarrier spacing of 15 kHz, the slot is configured to have the same length of 1 ms as that of the subframe. On the other hand, in the case of a numerology having a subcarrier spacing of 30 kHz, the slot includes 14 OFDM symbols, but one subframe may include two slots each having a length of 0.5 ms. That is, the subframe and the frame may be defined using a fixed time length, and the slot may be defined as the number of symbols such that the time length thereof is varied depending on the subcarrier spacing.

NR defines a basic unit of scheduling as a slot and also introduces a minislot (or a subslot or a non-slot-based schedule) in order to reduce a transmission delay of a radio section. If wide subcarrier spacing is used, the length of one slot is shortened in inverse proportion thereto, thereby reducing a transmission delay in the radio section. A minislot (or subslot) is intended to efficiently support URLLC scenarios, and the minislot may be scheduled in 2, 4, or 7 symbol units.

In addition, unlike LTE, NR defines uplink and downlink resource allocation as a symbol level in one slot. In order to reduce a HARQ delay, the slot structure capable of directly transmitting HARQ ACK/NACK in a transmission slot has been defined. Such a slot structure is referred to as a “self-contained structure”, which will be described.

NR was designed to support a total of 256 slot formats, and 62 slot formats thereof are used in 3GPP Rel-15. In addition, NR supports a common frame structure constituting an FDD or TDD frame through combinations of various slots. For example, NR supports i) a slot structure in which all symbols of a slot are configured for a downlink, ii) a slot structure in which all symbols are configured for an uplink, and iii) a slot structure in which downlink symbols and uplink symbols are mixed. In addition, NR supports data transmission that is scheduled to be distributed to one or more slots. Accordingly, the base station may inform the UE of whether the slot is a downlink slot, an uplink slot, or a flexible slot using a slot format indicator (SFI). The base station may inform a slot format by instructing, using the SFI, the index of a table configured through UE-specific RRC signaling. Further, the base station may dynamically instruct the slot format through downlink control information (DCI) or may statically or quasi-statically instruct the same through RRC signaling.

### <Physical Resources of NR>

With regard to physical resources in NR, antenna ports, resource grids, resource elements, resource blocks, bandwidth parts, and the like are taken into consideration.

The antenna port is defined to infer a channel carrying a symbol on an antenna port from the other channel carrying another symbol on the same antenna port. If large-scale properties of a channel carrying a symbol on an antenna port can be inferred from the other channel carrying a symbol on another antenna port, the two antenna ports may have a quasi-co-located or quasi-co-location (QC/QCL) relationship. The large-scale properties include at least one of delay spread, Doppler spread, a frequency shift, an average received power, and a received timing.

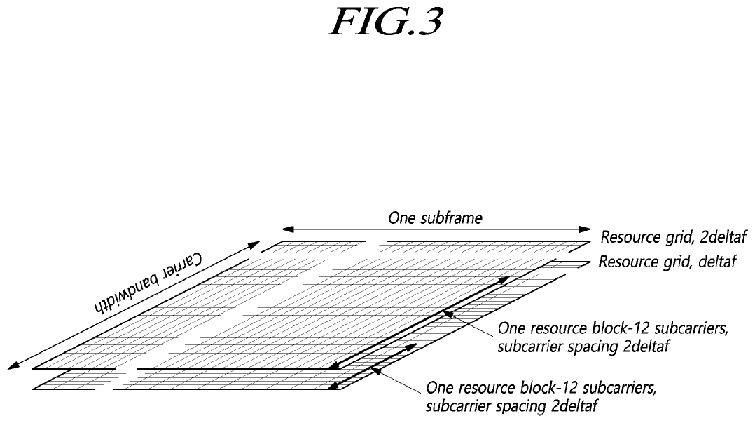

FIG. 3 illustrates resource grids supported by a radio access technology in accordance with embodiments of the present disclosure.

Referring to FIG. 3, resource grids may exist according to respective numerologies because NR supports a plurality of numerologies in the same carrier. In addition, the resource grids may exist depending on antenna ports, subcarrier spacing, and transmission directions.

A resource block includes 12 subcarriers and is defined only in the frequency domain. In addition, a resource element includes one OFDM symbol and one subcarrier. Therefore, as shown in FIG. 3, the size of one resource block may be varied according to the subcarrier spacing. Further, “Point A” that acts as a common reference point for the resource block grids, a common resource block, and a virtual resource block are defined in NR.

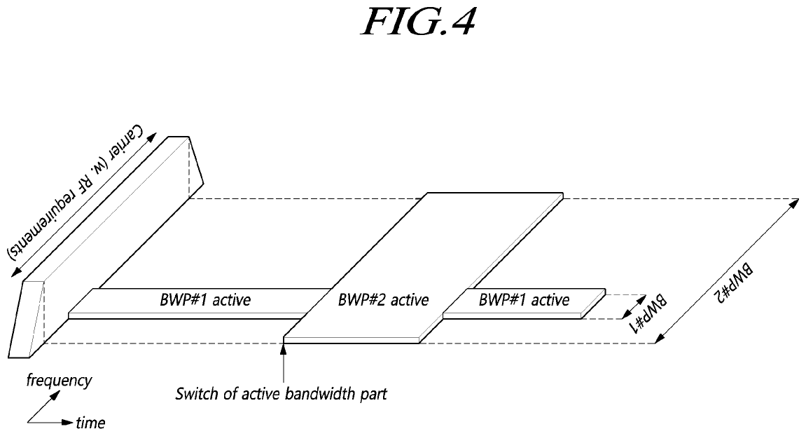

FIG. 4 illustrates bandwidth parts supported by a radio access technology in accordance with embodiments of the present disclosure.

Unlike LTE in which the carrier bandwidth is fixed to 20 MHZ, the maximum carrier bandwidth is configured as 50 MHz to 400 MHz depending on the subcarrier spacing in NR. Therefore, it is not assumed that all UEs use the entire carrier bandwidth. Accordingly, as shown in FIG. 4, bandwidth parts (BWPs) may be specified within the carrier bandwidth in NR so that the UE may use the same. In addition, the bandwidth part may be associated with one numerology, may include a subset of consecutive common resource blocks, and may be activated dynamically over time. The UE has up to four bandwidth parts in each of the uplink and the downlink. The UE transmits and receives data using an activated bandwidth part during a given time.

In the case of a paired spectrum, uplink and downlink bandwidth parts are configured independently. In the case of an unpaired spectrum, in order to prevent unnecessary frequency re-tuning between a downlink operation and an uplink operation, the downlink bandwidth part and the uplink bandwidth part are configured in pairs to share a center frequency.

### <Initial Access in NR>

In NR, a UE performs a cell search and a random access procedure in order to access and communicates with a base station.

The cell search is a procedure of the UE for synchronizing with a cell of a corresponding base station using a synchronization signal block (SSB) transmitted from the base station and acquiring a physical-layer cell ID and system information.

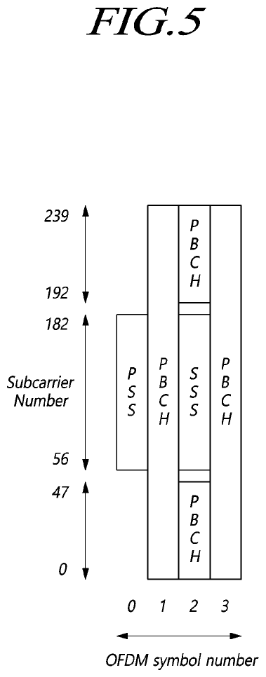

FIG. 5 illustrates an example of a synchronization signal block in a radio access technology in accordance with embodiments of the present disclosure.

Referring to FIG. 5, the SSB includes a primary synchronization signal (PSS) and a secondary synchronization signal (SSS), which occupy one symbol and 127 subcarriers, and PBCHs spanning three OFDM symbols and 240 subcarriers.

The UE monitors the SSB in the time and frequency domain, thereby receiving the SSB.

The SSB may be transmitted up to 64 times for 5 ms. A plurality of SSBs are transmitted by different transmission beams within a time of 5 ms, and the UE performs detection on the assumption that the SSB is transmitted every 20 ms based on a specific beam used for transmission. The number of beams that may be used for SSB transmission within 5 ms may be increased as the frequency band is increased. For example, up to 4 SSB beams may be transmitted at a frequency band of 3 GHz or less, and up to 8 SSB beams may be transmitted at a frequency band of 3 to 6 GHz. In addition, the SSBs may be transmitted using up to 64 different beams at a frequency band of 6 GHz or more.

One slot includes two SSBs, and a start symbol and the number of repetitions in the slot are determined according to subcarrier spacing as follows.

Unlike the SS in the typical LTE system, the SSB is not transmitted at the center frequency of a carrier bandwidth. That is, the SSB may also be transmitted at the frequency other than the center of the system band, and a plurality of SSBs may be transmitted in the frequency domain in the case of supporting a broadband operation. Accordingly, the UE monitors the SSB using a synchronization raster, which is a candidate frequency position for monitoring the SSB. A carrier raster and a synchronization raster, which are the center frequency position information of the channel for the initial connection, were newly defined in NR, and the synchronization raster may support a fast SSB search of the UE because the frequency spacing thereof is configured to be wider than that of the carrier raster.

The UE may acquire an MIB over the PBCH of the SSB. The MIB (master information block) includes minimum information for the UE to receive remaining minimum system information (RMSI) broadcast by the network. In addition, the PBCH may include information on the position of the first DM-RS symbol in the time domain, information for the UE to monitor SIB1 (e.g., SIB1 numerology information, information related to SIB1 CORESET, search space information, PDCCH-related parameter information, etc.), offset information between the common resource block and the SSB (the position of an absolute SSB in the carrier is transmitted via SIB1), and the like. The SIB1 numerology information is also applied to some messages used in the random access procedure for the UE to access the base station after completing the cell search procedure. For example, the numerology information of SIB1 may be applied to at least one of the messages 1 to 4 for the random access procedure.

The above-mentioned RMSI may mean SIB1 (system information block 1), and SIB1 is broadcast periodically (e.g., 160 ms) in the cell. SIB1 includes information necessary for the UE to perform the initial random access procedure, and SIB1 is periodically transmitted over a PDSCH. In order to receive SIB1, the UE must receive numerology information used for the SIB1 transmission and the CORESET (control resource set) information used for scheduling of SIB1 over a PBCH. The UE identifies scheduling information for SIB1 using SI-RNTI in the CORESET. The UE acquires SIB1 on the PDSCH according to scheduling information. The remaining SIBs other than SIB1 may be periodically transmitted, or the remaining SIBs may be transmitted according to the request of the UE.

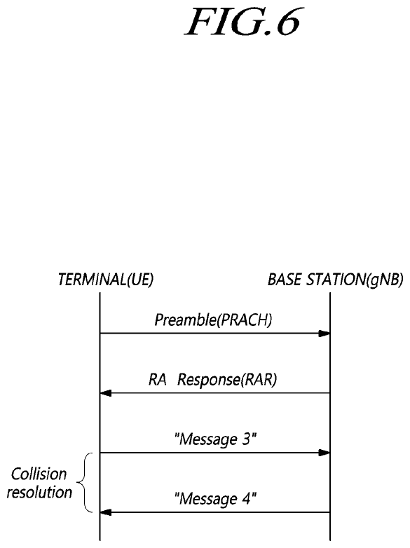

FIG. 6 is a view for explaining a random access procedure in a radio access technology to which the present embodiment is applicable.

Referring to FIG. 6, if a cell search is completed, the UE transmits a random access preamble for random access to the base station. The random access preamble is transmitted over a PRACH. Specifically, the random access preamble is periodically transmitted to the base station over the PRACH that includes consecutive radio resources in a specific slot repeated. In general, a contention-based random access procedure is performed when the UE makes initial access to a cell, and a non-contention-based random access procedure is performed when the UE performs random access for beam failure recovery (BFR).

The UE receives a random access response to the transmitted random access preamble. The random access response may include a random access preamble identifier (ID), UL Grant (uplink radio resource), a temporary C-RNTI (temporary cell-radio network temporary identifier), and a TAC (time alignment command). Since one random access response may include random access response information for one or more UEs, the random access preamble identifier may be included in order to indicate the UE for which the included UL Grant, temporary C-RNTI, and TAC are valid. The random access preamble identifier may be an identifier of the random access preamble received by the base station. The TAC may be included as information for the UE to adjust uplink synchronization. The random access response may be indicated by a random access identifier on the PDCCH, i.e., a random access-radio network temporary identifier (RA-RNTI).

Upon receiving a valid random access response, the UE processes information included in the random access response and performs scheduled transmission to the base station. For example, the UE applies the TAC and stores the temporary C-RNTI. In addition, the UE transmits, to the base station, data stored in the buffer of the UE or newly generated data using the UL Grant. In this case, information for identifying the UE must be included in the data.

Lastly, the UE receives a downlink message to resolve the contention.

### <NR CORESET>

The downlink control channel in NR is transmitted in a CORESET (control resource set) having a length of 1 to 3 symbols, and the downlink control channel transmits uplink/downlink scheduling information, an SFI (slot format index), TPC (transmit power control) information, and the like.

As described above, NR has introduced the concept of CORESET in order to secure the flexibility of a system. The CORESET (control resource set) refers to a time-frequency resource for a downlink control signal. The UE may decode a control channel candidate using one or more search spaces in the CORESET time-frequency resource. CORESET-specific QCL (quasi-colocation) assumption is configured and is used for the purpose of providing information on the characteristics of analogue beam directions, as well as delay spread, Doppler spread, Doppler shift, and an average delay, which are the characteristics assumed by existing QCL.

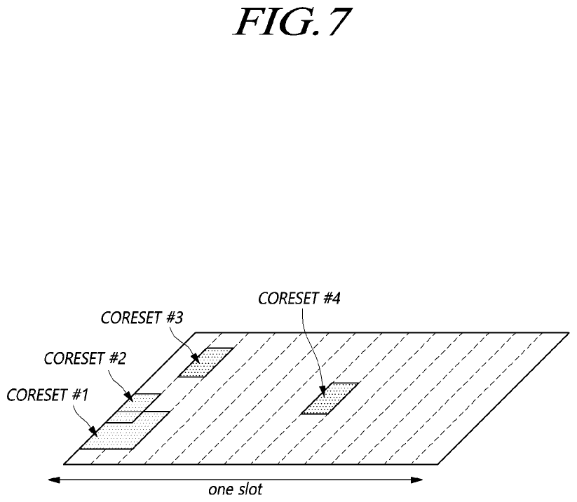

FIG. 7 illustrates CORESET.

Referring to FIG. 7, CORESETs may exist in various forms within a carrier bandwidth in a single slot, and the CORESET may include a maximum of 3 OFDM symbols in the time domain. In addition, the CORESET is defined as a multiple of six resource blocks up to the carrier bandwidth in the frequency domain.

A first CORESET, as a portion of the initial bandwidth part, is designated (e.g., instructed, assigned) through an MIB in order to receive additional configuration information and system information from a network. After establishing a connection with the base station, the UE may receive and configure one or more pieces of CORESET information through RRC signaling.

In this specification, a frequency, a frame, a subframe, a resource, a resource block, a region, a band, a subband, a control channel, a data channel, a synchronization signal, various reference signals, various signals, or various messages in relation to NR (New Radio) may be interpreted as meanings used at present or in the past or as various meanings to be used in the future.

### NR (New Radio)

NR is designed not only to provide an improved data transmission rate but also to satisfy various QoS requirements for different and specific usage scenario, compared to the LTE/LTE-Advanced. In particular, an enhanced mobile broadband (eMBB), massive machine-type communications (mMTC), and ultra reliable and low latency communication (URLLC) are defined as representative usage scenarios of the NR. To meet requirements for each usage scenario, it is required to design the NR to have a more flexible frame structure than the LTE/LTE-Advanced.

Since each usage scenario imposes different requirements for data rates, latency, coverage, etc., there is a need to efficiently multiplex numerology-based (e.g., a subcarrier spacing (SCS), a subframe, a transmission time interval (TTI), etc.) radio resource units different from each other, as a solution to efficiently meet the requirements of each usage scenario within a frequency band provided to an NR system.

To this end, there have been discussions on i) methods of multiplexing numerologies having subcarrier spacing (SCS) values different from one another based on TDM, FDM or TDM/FDM over one NR carrier, and ii) methods of supporting one or more time units in configuring a scheduling unit in the time domain. In this regard, in NR defines a subframe as one type of a time domain structure. In addition, as a reference numerology for defining the corresponding subframe duration, a single subframe duration is defined to include 14 OFDM symbols of normal CP overhead based on 15 kHz subcarrier spacing (SCS), like LTE. Therefore, the subframe of the NR has the time duration of 1 ms. Unlike LTE, since the subframe of the NR is an absolute reference time duration, a slot and a mini-slot may be defined as a time unit for actual UL/DL data scheduling. In this case, the number of OFDM symbols which constitutes a slot (denoted as y) is defined as y=14 regardless of numerology.

Therefore, a slot may be made up of 14 symbols. In accordance with a transmission direction for a corresponding slot, all symbols may be used for DL transmission or UL transmission, or the symbols may be used in the configuration of a DL portion+a gap+a UL portion.

Further, a mini-slot is defined to be made up of fewer symbols than the slot in a numerology (or SCS), and as a result, a short time domain scheduling interval may be configured for UL/DL data transmission or reception based on the mini-slot. Also, a long time domain scheduling interval may be configured for the UL/DL data transmission or reception by slot aggregation.

Particularly, in the case of the transmission or reception of latency critical data, such as the URLLC, when scheduling is performed on a slot basis based on 1 ms (14 symbols) defined in a frame structure based on a numerology having a small SCS value, for example, 15 kHz, latency requirements may be difficult to be satisfied. To this end, a mini-slot made up of fewer OFDM symbols than the slot may be defined, and thus the scheduling for the latency critical data, such as the URLLC, may be performed based on the mini-slot.

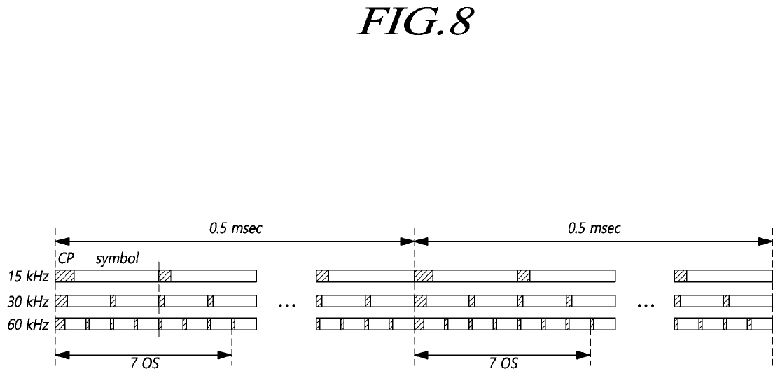

As described above, it is also contemplated to schedule the data according to the latency requirement based on the length of the slot (or minislot) defined by the numerology by supporting the numerology with the different SCS values in one NR carrier by multiplexing them in the TDM and/or FDM manner. For example, as shown in FIG. 8, when the SCS is 60 kHz, the symbol length is reduced to about ¼ of that of the SCS 15 kHz. Therefore, when one slot is made up of 14 OFDM symbols, the slot length based on 15 kHz is 1 ms whereas the slot length based on 60 kHz is reduced to about 0.25 ms.

Thus, since different SCSs or different TTI lengths from one another are defined in NR, technologies have been developed for satisfying requirements of each of the URLLC and the eMBB.

### Wider Bandwidth Operations

The typical LTE system supports scalable bandwidth operations for any LTE CC (component carrier). That is, according to a frequency deployment scenario, an LTE provider may configure a bandwidth of a minimum of 1.4 MHz to a maximum of 20 MHz in configuring a single LTE CC, and a normal LTE UE supports a transmission/reception capability of a bandwidth of 20 MHz for a single LTE CC.

However, the NR is designed to support the UE of NR having different transmission/reception bandwidth capabilities over a single wideband NR CC. Accordingly, it is required to configure one or more bandwidth parts (BWPs) including subdivided bandwidths for an NR CC, thereby supporting a flexible and wider bandwidth operation through configuration and activation of different bandwidth parts for respective UEs.

Specifically, one or more bandwidth parts may be configured through a single serving cell configured for a UE in NR, and the UE is defined to activate one downlink (DL) bandwidth part and one uplink (UL) bandwidth part to use the same for uplink/downlink data transmission/reception in the corresponding serving cell. In addition, in the case where a plurality of serving cells is configured for the UE (i.e., the UE to which CA is applied), the UE is also defined to activate one downlink bandwidth part and/or one uplink bandwidth part in each serving cell to use the same for uplink/downlink data transmission/reception by utilizing radio resources of the corresponding serving cell.

Specifically, an initial bandwidth part for an initial access procedure of a UE may be defined in a serving cell; one or more UE-specific bandwidth parts may be configured for each UE through dedicated RRC signaling, and a default bandwidth part for a fallback operation may be defined for each UE.

It is possible to define simultaneously activating and using a plurality of downlink and/or uplink bandwidth parts according to the capability of the UE and the configuration of the bandwidth parts in a serving cell. However, NR rel-15 defined activating and using only one downlink (DL) bandwidth part and one uplink (UL) bandwidth part at a time.

The disclosure relates to wireless connectivity technology of a UE in a wireless mobile communication system. In particular, the disclosure provides a method for enhancing wireless connectivity of a UE based on multiple UE groups.

With continuous release of smart devices providing various user experiences recently, the types and number of smart devices owned by a user are increasing. In particular, smart devices require wireless connectivity functionality to support firmware/software update, enable intelligent control/management, and provide various new cloud-based content according to types and purposes. Further, existing devices such as automobiles and home appliances also support functions such as delivering infotainment content and performing remote diagnosis/control/management based on wireless connectivity. Further, the number of devices and service scenarios requiring wireless connectivity continues to grow across various B2B business areas, including surveillance cameras, factory automation, and remote medical care.

In other words, the types and number of cellular-based wireless connectable user devices, previously represented by smartphones, are gradually expanding to encompass various MTC/IoT devices for different purposes, automobiles, and wearable devices such as smartwatches and smart glasses. As a result, the cellular-based wireless connectivity devices owned by any one subscriber are diversifying from a single smartphone to various devices, including automobiles, wearable devices, and tablets. Furthermore, the variety and number of mobile devices supporting cellular-based wireless connectivity are expected to further increase with the further commercialization of 6G.

As devices requiring such wireless connectivity and their applications diversify, various wireless QoS requirements may arise depending on different applications, and accordingly, a method for optimizing wireless connectivity performance is needed. Further, each device may have limitations in its form factor (e.g., size or material), which may result in differences in antenna aperture or modem chip performance supporting wireless connectivity.

Meanwhile, in existing cellular mobile communication systems (e.g., LTE/LTE-A, NR, etc.), wireless connectivity for data transmission/reception has been provided through a UE connecting to an operator node (e.g., eNB, gNB, Relay Node, IAB Node, Repeater, etc.) installed by any operator to provide wireless coverage. Specifically, a UE establishes wireless connectivity by connecting to a single operator node over a single frequency carrier.

However, according to existing cellular mobile communication technology, as a method for extending user device connectivity and enhancing data transmission speed, carrier aggregation (CA) technology that connects through one or more carriers, or dual/multi Connectivity (DC/MC) technology that establishes connections with one or more nodes for wireless signal transmission and reception, may be supported. Further, connectivity expansion technologies through aggregation or simultaneous connection (MPTCP; Multipath TCP) between different radio access technologies (RAT) such as cellular and Wi-Fi may also be supported. In other words, the wireless connection quality achievable by a user device was determined by the deployment topology of operator nodes constructed by a wireless operator and by the frequencies those nodes support. That is, the provision of wireless connectivity for a UE depends on the operator's wireless node deployment topology.

Accordingly, the disclosure provides a technology for extending wireless connectivity beyond typical methods, by utilizing other wireless devices to meet the requirements arising from the recent introduction of various wireless devices and services.

Hereinafter, a method for performing wireless communication with enhanced connectivity using auxiliary devices is described in detail with reference to the accompanying drawings.

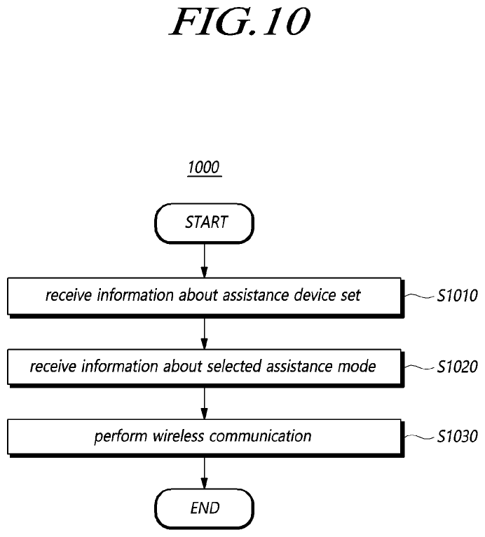

FIG. 10 is a flowchart illustrating a method 1000 for a UE to perform wireless communication with enhanced wireless connectivity according to an embodiment.

Referring to FIG. 10, the UE may receive information about an assistance device set including at least one assistance device selected from within an assistance device pool (S1010).

When the UE performs wireless communication, a separate wireless device may be used as an assistance device to enhance wireless connectivity. To that end, at least one wireless device capable of operating as an assistance device for the UE may be configured into an assistance device pool. The assistance device pool may be configured and managed by an operator device that provides the wireless communication service subscribed to by the UE.

According to an embodiment, the assistance device pool may include at least one wireless device subscribed to by the subscriber of the UE or at least one wireless device subscribed to by a subscriber group that includes the subscriber.

For example, assume a scenario in which at least one wireless device, such as a tablet, a wearable device, a vehicle, in addition to the UE, is subscribed to the same operator as the UE's subscriber. In this case, the wireless devices subscribed to by the subscriber may be configured as a subscriber-specific assistance device pool.

Alternatively, the wireless devices subscribed to by a subscriber group including one or more subscribers may be configured as an assistance device pool. For example, the wireless devices subscribed to by a subscriber group that includes subscriber of the UE's subscriber, such as family members, corporations, or small businesses, may be configured as a subscriber-specific assistance device pool.

In this case, a separate subscriber ID or subscriber group ID may be allocated to each of the wireless devices included in the assistance device pool. In other words, when the assistance devices are configured as an assistance device pool, a subscriber ID or subscriber group ID may be allocated and managed by the operator.

According to another embodiment, the assistance device pool may include at least one wireless device supporting an assistance device function that can operate as an assistance device in multiple assistance modes. In this case, regardless of the subscriber's UE, the wireless devices capable of operating as assistance devices may be configured as a common assistance device pool independent of the subscriber. In other words, when any subscriber UE has an assistance device function or allows/activates use as an assistance device, the UE may be included in and managed by the common assistance device pool by the operator.

According to an embodiment, the assistance device pool may be configured and managed per cell by the base station. Alternatively, the assistance device pool may be configured and managed on a per-tracking-area unit or per-cell-group unit by a mobility control management entity in the core network such as a mobility management entity (MME).

The UE may receive information about the assistance device pool from the base station. According to an embodiment, the information about the assistance device pool may be received through higher layer signaling such as RRC signaling.

According to an embodiment, the UE may receive information about an assistance device set including at least one assistance device selected from the assistance device pool from the base station. Hereinafter, it is described as an assistance device set but, without limitations, it may also be referred to by other terms, such as an assistance device group.

The base station may configure an assistance device set from within the assistance device pool to enhance wireless quality for a UE in a cell. The assistance device set for the UE may include wireless devices capable of operating as assistance devices among the wireless devices included in the assistance device pool when the set is configured.

According to an embodiment, the assistance device set may include wireless devices that have transmitted a response to an assistance request for operating as an assistance device, among the wireless devices included in the assistance device pool. In other words, when the base station intends to perform communication according to an assistance mode, the base station may transmit an assistance request message to the wireless devices belonging to the assistance device pool. The wireless devices send a response message accepting the assistance request message may be configured as the assistance device set.

The wireless devices in the assistance device set for the UE configured as described above may be utilized as candidate devices for selecting an assistance device and assistance mode for the UE, and as a target device group or set for direct link state information feedback with the UE.

In this case, an assistance device set ID and a device ID within the assistance device set may be allocated to each of the assistance devices that are part of the assistance device set.

Alternatively, according to another embodiment, a separate assistance device set may not be configured. All wireless devices included in the assistance device pool in the cell where the UE is located may be defined as assistance devices within the assistance device set. Accordingly, all wireless devices in the assistance device pool may be utilized as candidate devices for selecting an assistance device and assistance mode for the UE, and as an assistance device set serving as a target for direct link state information feedback with the UE.

According to an embodiment, the information about the assistance device set may be received through higher layer signaling such as RRC signaling. Alternatively, the information about the assistance device set may be indicated by downlink control information.

Referring back to FIG. 10, the UE may receive information about an assistance mode selected from multiple assistance modes utilizing the assistance device set for wireless communication with the base station (S1020).

According to an embodiment, multiple assistance modes may include i) a first assistance mode that utilizes only a wireless link with the assistance device set and ii) a second assistance mode that utilizes both a wireless link with the base station and a wireless link with the assistance device set.

The first assistance mode (hereinafter also referred to as assistance relay mode) refers to a route selection type assistance mode that operates to enhance wireless quality for the UE. According to the first assistance mode, when determining that wireless quality through a relayed wireless link through an assistance device is superior to wireless quality through a wireless link directly connected to the base station, an optimal assistance device may be selected and a link with the UE may be established in a relay manner.

The second assistance mode (hereinafter also referred to as cooperative transmission mode) refers to a cooperative transmission type assistance mode that operates to enhance the wireless communication quality for the UE. According to the second assistance mode, wireless connectivity for the UE may be extended through a plurality of wireless links by establishing an additional wireless link through a relayed link through an assistance device in addition to a direct wireless link (i.e., Uu interface) between the base station and the UE.

In this case, the second assistance mode may include a first mode in which the wireless link with the base station and the wireless link with the assistance device set are configured on different frequency bands, a second mode in which the wireless link with the base station and the wireless link with the assistance device set are configured on the same frequency band, and a third mode in which the wireless link with the base station and the wireless link with the assistance device set are configured with different radio access technologies (RAT).

In the case of the first mode of the second assistance mode, the wireless link with the base station and the wireless link with the assistance device at the UE may be configured to operate in different frequency bands. In this case, the two different frequency bands may be aggregated and used through carrier aggregation (CA) or dual connectivity (DC) manner.

In the case of the second mode of the second assistance mode, the wireless link with the base station and the wireless link with the assistance device at the UE may be configured to operate on the same frequency band. The UE may perform transmission/reception through the wireless link with the base station and the wireless link with the assistance device separately in at least one of a spatial domain, a frequency domain, or a time domain.

In the case of the third mode of the second assistance mode, the wireless link with the base station and the wireless link with the assistance device at the UE may be configured using different radio access technologies. In other words, the direct link between the assistance device and the UE may not be established based on cellular sidelink (i.e., PC5 interface based) but may be established through another RAT such as Wi-Fi, Bluetooth, etc. The UE may aggregate the wireless link with the base station and the wireless link with the assistance device through a multipath TCP (MPTCP) protocol.

Although the disclosure describes the second assistance mode as being configured by establishing one additional wireless link through a single assistance device, in addition to the wireless link between the base station and the UE, it is not limited thereto. The technical spirit of the disclosure may be equally applicable to cases in which cooperative communication is performed by configuring multiple additional wireless links through two or more assistance devices. Further, the frequencies on which the above-described wireless links operate may each include not only one component carrier (CC) but also multiple CCs. In other words, even when multiple CCs are used for each wireless link between the UE and the base station, and the wireless link between the UE and the assistance device, the technical spirit of the disclosure may be substantially equally applied.

According to an example, the assistance mode to be used for wireless communication may be selected based on channel state information for a wireless link between the UE and each of at least one wireless device included in the assistance device pool or the assistance device set. To that end, the UE may report direct link channel state information for a wireless device included in the assistance device pool or assistance device set configured for the UE to the base station. The direct link channel state information may include information, such as the operating frequency of the PC5 link used for configuring the direct link, maximum bandwidth, maximum transmission rate, capacity, or CQI/RI. Alternatively, for support of the third mode of the second assistance mode, RAT information to direct link connection or other relevant parameters may be additionally included.

The base station may select an appropriate assistance mode based on the report provided by the UE. For example, when the state of the wireless link between the UE and the assistance device is good and the state of the wireless link between the UE and the base station is poor, the first assistance mode may be selected. Alternatively, when it is determined that the wireless link between the UE and the base station requires enhancement through an additional wireless link, the second assistance mode may be selected. In this case, an optimal mode may be selected from among the three modes included in the second assistance modes according to the state of the wireless links with the assistance devices. The base station may transmit information about the selected assistance mode to both the UE and the corresponding assistance device. The information about the selected assistance mode may further include direct link configuration information between the assistance device and the UE.

Referring back to FIG. 10, the UE may perform wireless communication through at least one of the wireless link with the base station or the wireless link with the assistance device set based on the information about the selected assistance mode (S1030).

According to an embodiment, the UE may receive scheduling control information from the base station, which include i) Uu link scheduling information between the base station and the UE, ii) Uu link scheduling information between the base station and the assistance device for cooperative communication, and iii) PC5 link scheduling control information between the assistance device and the UE from the base station through one scheduling control information according to the selected assistance mode.

Alternatively, according to another embodiment, the UE may receive Uu link scheduling information and PC5 link scheduling control information from the base station through separate scheduling control information respectively. In particular, when a single scheduling control message is used, group ID information, such as group-C-RNTI information, may be further included in the information about the assistance mode for both the assistance device and the UE to receive the scheduling control information.

The UE may perform wireless communication with the base station according to the received scheduling-control information.

According to the embodiments described above, wireless communication may be performed between the UE and the base station with enhanced wireless connectivity.

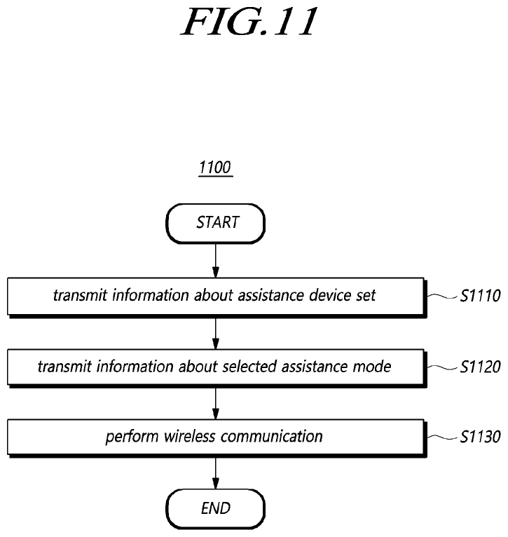

FIG. 11 is a flowchart illustrating a method 1100 for a base station to perform wireless communication with enhanced wireless connectivity according to an embodiment. The description provided above with reference to FIG. 10 may be omitted to avoid redundant description, and in this case, the omitted content may be equally applicable to the base station, provided that it does not conflict with the technical spirit of the present disclosure.

Referring to FIG. 11, the base station may transmit information about an assistance device set including at least one assistance device selected from an assistance device pool (S1110).

According to an embodiment, the assistance device pool may include at least one wireless device subscribed to by the subscriber of the UE or at least one wireless device subscribed to by a subscriber group that includes the subscriber.

Alternatively, the wireless devices subscribed to by a subscriber group including one or more subscribers may be configured as an assistance device pool.

In this case, a separate subscriber ID or subscriber group ID may be allocated to each of the wireless devices constituting the assistance device pool. In other words, when the assistance devices are configured as an assistance device pool, a subscriber ID or subscriber group ID may be allocated and managed by the operator.

According to another embodiment, the assistance device pool may include at least one wireless device supporting an assistance device function capable of operating as an assistance device in the plurality of assistance modes. In this case, regardless of the subscriber's UE, the wireless devices capable of operating as assistance devices may be configured as a common assistance device pool independent of the subscriber. In other words, when any subscriber UE has an assistance device function or allows/activates use as an assistance device, the UE may be included in and managed by the common assistance device pool by the operator.

According to an embodiment, the assistance device pool may be configured and managed per cell by the base station. Alternatively, the assistance device pool may be configured and managed on a per tracking area unit or per cell group unit by a mobility control management entity in the core network, such as a mobility management entity (MME).

The base station may transmit information about the assistance device pool to the UE. According to an embodiment, the information about the assistance device pool may be transmitted through higher layer signaling such as RRC signaling.

According to an embodiment, the base station may transmit information about an assistance device set including at least one assistance device selected from within the assistance device pool to the UE.

The base station may configure an assistance device set from within the assistance device pool to enhance wireless quality for a UE in a cell. The assistance device set for the UE may include wireless devices capable of operating as assistance devices among the wireless devices included in the assistance device pool when the set is configured.

According to an example, the assistance device set may include wireless devices that have transmitted a response to an assistance request for operating as an assistance device, among at least one wireless device included in the assistance device pool. In other words, when the base station intends to perform communication according to an assistance mode, the base station may transmit an assistance request message to the wireless devices belonging to the assistance device pool. The wireless devices that send a response message accepting the assistance request message may be configured as the assistance device set.

In this case, an assistance device set ID and a device ID within the assistance device set may be allocated to each of the assistance devices included in the assistance device set.

Alternatively, according to another embodiment, a separate assistance device set may not be configured, and all wireless devices belonging to the assistance device pool in the cell where the UE is located may be defined as assistance devices within the assistance device set. Accordingly, all wireless devices in the assistance device pool may be utilized as candidate devices for selecting an assistance device and an assistance mode for the UE, and as an assistance device set serving as a target for direct link state information feedback with the UE.

According to an embodiment, the base station may transmit information about the assistance device set through higher layer signaling such as RRC signaling. Alternatively, the base station may indicate information about the assistance device set through downlink control information.

Referring to FIG. 11, the base station may transmit information about an assistance mode selected from among multiple assistance modes utilizing the assistance device set for wireless communication with the UE (S1120).

According to an embodiment, the multiple assistance modes may include a first assistance mode utilizing only a wireless link with the assistance device set and a second assistance mode utilizing both a wireless link with the base station and a wireless link with the assistance device set.

The first assistance mode refers to a route selection type assistance mode that operates to enhance the wireless communication quality of the UE. According to the first assistance mode, when it is determined that the wireless quality through a relayed wireless link via an assistance device is superior to that of a wireless link directly connected to the base station, an optimal assistance device may be selected, and a link with the UE may be established in a relay manner.

The second assistance mode refers to a cooperative transmission type assistance mode that operates to enhance the wireless communication quality of the UE. According to the second assistance mode, that wireless connectivity of the UE may be extended through multiple wireless links by establishing an additional wireless link via a relayed connection through an assistance device, in addition to a direct wireless link (i.e., Uu interface) between the base station and the UE.

In this case, the second assistance mode may include i) a first mode in which the wireless link with the base station and the wireless link with the assistance device set are configured on different frequency bands, ii) a second mode in which the wireless link with the base station and the wireless link with the assistance device set are configured on the same frequency band, and iii) a third mode in which the wireless link with the base station and the wireless link with the assistance device set are configured using different radio access technologies (RAT).

In the case of the first mode of the second assistance mode, the wireless link with the base station and the wireless link with the assistance device at the UE may be configured to operate in different frequency bands. In this case, the two different frequency bands may be aggregated and used through carrier aggregation (CA) or dual connectivity (DC) manner.

In the case of the second mode of the second assistance mode, the wireless link with the base station and the wireless link with the assistance device at the UE may be configured to operate in the same frequency band. The UE may perform transmission/reception through the wireless link with the base station and the wireless link with the assistance device separately in at least one of a spatial domain, a frequency domain, or a time domain.

In the case of the third mode of the second assistance mode, the wireless link with the base station and the wireless link with the assistance device at the UE may be configured using different radio access technologies. In other words, the direct link between the assistance device and the UE may not be established based on cellular sidelink (i.e., PC5 interface based) but may be established through another RAT such as Wi-Fi, Bluetooth, etc. The UE may aggregate the wireless link with the base station and the wireless link with the assistance device through a multipath TCP (MPTCP) protocol.

According to an embodiment the assistance mode for wireless communication may be selected based on channel state information for a wireless link between the UE and each of at least one wireless device included in the assistance device pool or the assistance device set. To that end, the UE may report direct link channel state information for a wireless device included in the assistance device pool or assistance device set configured for the UE to the base station. The direct link channel state information may include information, such as the operating frequency of the PC5 link used for configuring the direct link, maximum bandwidth, maximum transmission rate, capacity, or CQI/RI. Alternatively, for support of the third mode of the second assistance mode, RAT information related to the direct link connection or other relevant parameters may be additionally included.

The base station may select an appropriate assistance mode based on report of the UE. The base station may transmit information about the selected assistance mode to both the UE and the assistance device. The information about the selected assistance mode may further include direct link configuration information between the assistance device and the UE.

Referring to FIG. 11, the base station may perform wireless communication through at least one of the wireless link with the UE or the wireless link with the assistance device set based on the information about the selected assistance mode (S1130).

According to an embodiment, the base station may transmit i) Uu link scheduling information between the base station and the UE, ii) Uu link scheduling information between the base station and the assistance device for cooperative communication, and iii) PC5 link scheduling control information between the assistance device and the UE to the UE through one scheduling control information according to the selected assistance mode.

Alternatively, according to another embodiment, the base station may transmit the Uu link scheduling information and the PC5 link scheduling control information to the UE through separate scheduling control information respectively. In particular, when one scheduling control information is used, group ID information such as group-C-RNTI information may be further included in the information about the assistance mode for both the assistance device and the UE to receive the scheduling control information.

The base station may perform wireless communication with the UE according to the received scheduling information.

According to the embodiments described above, wireless communication may be performed between the UE and the base station with enhanced wireless connectivity.

Hereinafter, each embodiment related to performing wireless communication in an assistance mode using at least one assistance device is described in detail with reference to the accompanying drawings.

The disclosure proposes a user device group-based wireless connectivity provision technology for enhancing wireless connectivity performance of a specific user device by grouping wireless devices owned by the user or grouping other user devices that may help enhance wireless connectivity performance of the user device.

In particular, the disclosure proposes a user device connectivity expansion technology through interworking between PC5 interface, which is a wireless interface that configures a direct link between user devices, and a Uu interface, which configures a cellular link between an operator node and a user device.

In the disclosure, a user device such as a smartphone, a wearable device, an automobile, a wireless connected device, or other devices subscribed to by an individual user or a corporation/organization, and may be referred to by other terms such as a UE (User Equipment), a user UE, or a user equipment. Further, in the disclosure, a target device refers to a user device that receives help from surrounding assistance device(s) for wireless connectivity expansion.

The disclosure specifically includes the following technologies and devices.

It includes a function and device for configuring and managing an assistance device pool by defining candidate devices that may help enhance wireless connectivity expansion for any user device.

Further, it includes a function and device for configuring an assistance device group or assistance device set by grouping devices that may be used as assistance devices for wireless connectivity expansion for the target device among the devices included in the assistance device pool in the cell configured by the base station for connectivity expansion for any target device in any base station/cell/network.

It includes a function and device for selecting optimal assistance device(s) for wireless connectivity expansion for the target user device among the devices included in the assistance device group/set.

Based on this, it includes a function and device for setting and operating an interworking mode between the operator node and the selected assistance device(s) for wireless connectivity expansion of the target device. In the disclosure, the interworking mode between the target device and the assistance device(s) includes an assistance relaying mode through optimal route path selection and a cooperative transmission mode between the operator node and the assistance device(s). However, the interworking mode is not limited to those terms and may also be referred to using different terminology.

Further, it includes a method and device for the user equipment to transmit feedback information for selecting the assistance device(s) for another user equipment and for setting the interworking mode in the process.

### Embodiment 1: Assistance Device Pool and Assistance Device Group/Set Configuration

A user equipment group that may help enhance the wireless link quality between the user equipment and an operator node may be defined for any user equipment.

To that end, an operator may configure and manage an assistance device pool that may operate as assistance devices for any target equipment.

According to an embodiment, as one method of configuring an assistance device pool, it may be defined to configure a subscriber-specific assistance device pool limited to user equipment subscribed to by the same subscriber or subscriber group for each target device. In other words, when various wireless devices including a smartphone, a tablet, a wearable device, a vehicle are subscribed to by one subscriber, the assistance device pool may be restricted to include only the devices subscribed to by the subscriber. Alternatively, it may be defined to configure an assistance device pool by extending to user equipment subscribed to by a subscriber group including one or more subscribers (e.g., family, corporation, small business, etc.). In this case, a separate subscriber ID or subscriber group ID may be defined for each user equipment for configuring the assistance device pool and may be allocated and managed by the operator.

According to another embodiment, as another method of configuring an assistance device pool, a subscriber independent common assistance device pool may be configured by grouping devices capable of operating as assistance devices, i.e., devices with assistance device functionality or capability, regardless of the target device. In other words, for any subscriber UE, when the UE has an assistance device function or allows/activates operation as an assistance device, an operator may include and manage the UE in the common assistance device pool.

In both cases described above, any assistance device pool may be configured and managed on a per cell basis by a base station or may be configured and managed on a per tracking area or per cell group basis by a mobility management entity (MME).

Any base station/network/cell may configure or set an assistance device group or assistance device set from the assistance device pool to enhance wireless quality for any UE within the cell. The assistance device group or set for any target device may include devices capable of operating as assistance devices among the devices included in the subscriber-specific assistance device pool and/or common assistance device pool defined by the target device. To that end, transmission/reception of assistance request and response messages may be performed by UEs included in the subscriber-specific or common assistance device pool within the cell by the base station/network/cell. According to the result of transmission/reception of the assistance request and response messages, an assistance device group or set for any target device may be configured.

The assistance device group or set for any target device may be utilized as candidate devices for selecting assistance device(s) and assistance mode for the target device and as a target device group or set for direct link state information feedback with the target device described below. Further, each of the devices included in the assistance device group/set may be allocated an assistance device group/set ID and a device ID within the assistance device group/set.

Alternatively, without configuring a separate assistance device group/set, all devices belonging to the assistance device pool, particularly the assistance device pool within the cell where any target device is located, may be defined as devices within the assistance device group/set. Accordingly, all the devices may be utilized as candidate devices for selecting assistance device(s) and assistance mode for the target device and as a target device group or set for direct link state information feedback with the target device described below.

### Embodiment 2: Assistance Device(s), Assistance Mode Selection and Related Feedback Information

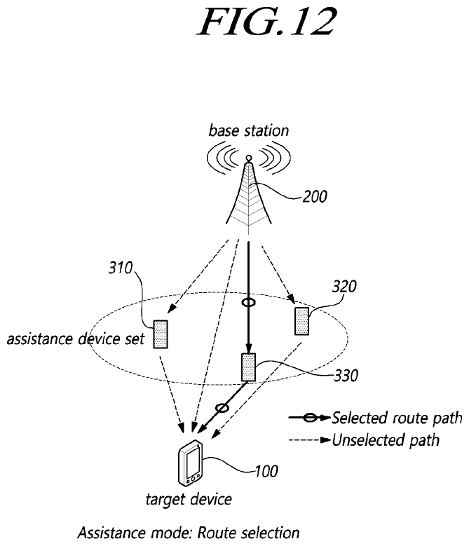

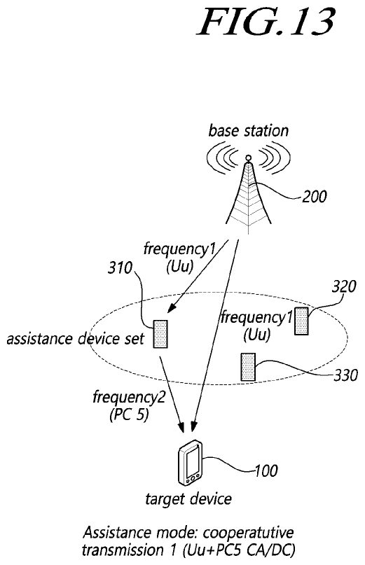

FIGS. 12 to 15 are diagrams illustrating a specific method for extending connectivity of a target UE proposed in the disclosure. FIG. 12 is a view illustrating a first assistance mode utilizing only a wireless link with an assistance device set according to an embodiment. FIGS. 13 to 15 are views illustrating a second assistance mode utilizing both a wireless link between a UE and a base station and a wireless link with an assistance device set according to an embodiment.

Specifically, assistance mode operation methods for enhancing wireless quality for any target device through assistance devices proposed in the disclosure include a route selection method and a cooperative transmission method. In the case of the route selection method, as illustrated in FIG. 12, when it is determined that the wireless quality through a relayed link via assistance devices 310, 320, 330 is superior to that of a direct wireless link between a target device 100 and an operator node (i.e., base station, relay, etc., 200), this method establishes a link with the target device by selecting an optimal assistance device 330 in a relaying manner.

On the other hand, the cooperative transmission method is a method of extending wireless connectivity for the target UE through multiple wireless links by establishing/activating an additional wireless link via a relayed connection through an assistance device, in addition to a direct wireless link (i.e., Uu interface) between the operator node and the target device. This method may be classified into three detailed modes, as illustrated in FIGS. 13 to 15, according to the frequency and RATs used between the Uu link between the operator node and the target UE and the direct link between the assistance device and the target device.

For example, referring to FIG. 13, in the case of cooperative transmission mode 1, when the Uu link operating frequency with the base station 200 and the PC5 link operating frequency with an assistance node 310 at the target UE 100 are different, the two frequencies are aggregated and through a CA or DC manner.

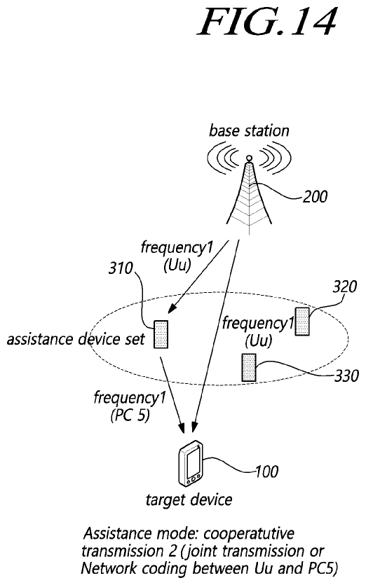

Further, referring to FIG. 14, in the case of a cooperative transmission mode 2, the Uu link with the base station 200 and the PC5 link with the assistance node 310 operate in the same frequency band for the target UE 100. In this case, the target UE 100 operates by distinguishing transmission/reception through the Uu link and the PC5 link in the spatial domain, the frequency domain, or the time domain.

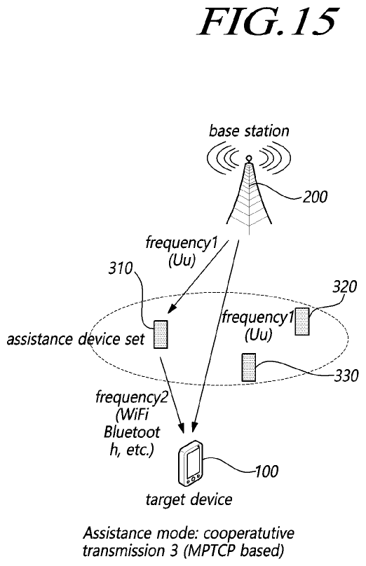

Finally, referring to FIG. 15, in the case of cooperative transmission mode 3, the direct link between the assistance device 310 and the target device 100 is not established based on cellular sidelink (i.e., PC5 based), but is instead established through another RAT (e.g., Wi-Fi, Bluetooth, etc.) and the corresponding data may be aggregated at the target device by means of the MPTCP protocol.

Although the description above is based on the case where a cooperative transmission mode is configured by configuring one additional link through one assistance device in addition to the Uu link between the operator node and the target device, it is not limited thereto. The same concept may be applied to other cases where cooperative transmission is performed by configuring a plurality of additional links through two or more assistance devices. Further, the above-described frequencies may each include not only one CC (Component Carrier) but also a plurality of CCs.

As described above, for selection and configuration of an assistance mode suitable for any target device (e.g., UE), any target device may be defined to report direct link channel state information with UEs belonging to the assistance device group/set or assistance device pool configured for the target device to the base station. The direct link channel state information may include operating frequency information of the PC5 link for direct link configuration, maximum bandwidth information, maximum transmission rate or capacity information, CQI/RI information, and the like. Alternatively, it may additionally include RAT information for direct link connection to support cooperative transmission mode 3.

The base station transmits appropriate assistance mode configuration information to each of the target device and the assistance device based on the direct link channel state reporting information of the target device. The configuration information may further include direct link configuration information between the assistance device and the target device (e.g., UE).

When the assistance mode configuration information and the resulting direct link between the assistance device(s) and the target device, as well as and Uu link configuration between the base station and the assistance device(s), are established, the base station may be configured to transmit i) Uu link scheduling information between the base station and the target device, ii) Uu link scheduling information between the base station and the assistance device for cooperative transmission, and iii) PC5 link scheduling control information between the assistance device and the target device through one scheduling control information for each assistance mode. Alternatively, the Uu link scheduling information and the PC5 link scheduling control information may be separately transmitted through respective scheduling control information messages. In particular, when transmitted through one scheduling control information, the assistance mode configuration information may include group ID information (e.g., group-C-RNTI information, etc.) for both the assistance device(s) and the target device to receive the scheduling control information.

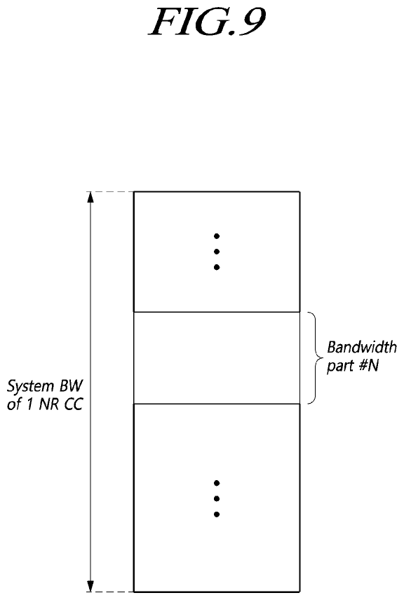

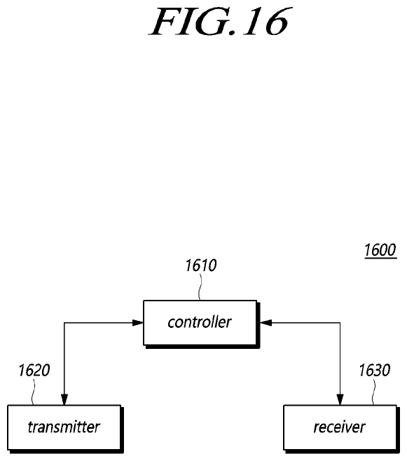

Configurations of a UE and a base station that may perform all or some of the embodiments described above in connection with FIGS. 1 to 15 are described below with reference to the drawings. The above-described description may be omitted to avoid redundant description and, in that case, the omitted content may be applied in substantially the same manner to the following description as long as it does not go against the technical spirit of the disclosure. FIG. 16 is a block diagram illustrating a UE 1600 according to an embodiment.

Referring to FIG. 18, a UE 1600 according to an embodiment includes a transmitter 1620, a receiver 1630, and a controller 1610 controlling operations of the transmitter and the receiver.

The controller 1610 controls the overall operations of the UE 1600 according to a method for performing wireless communication with enhanced wireless connectivity necessary for implementing the embodiments of the disclosure described above. Further, the controller 1610 may be configured to receive information about an assistance device set including at least one assistance device selected from within an assistance device pool, receive information about an assistance mode selected from among a plurality of assistance modes utilizing the assistance device set for wireless communication with a base station, and perform wireless communication through at least one of a wireless link with the base station or a wireless link with the assistance device set based on the information about the selected assistance mode.

When the UE 1600 performs wireless communication, a separate wireless device may be used as an assistance device to enhance wireless connectivity. To that end, at least one wireless device capable of operating as an assistance device for the UE may be configured as an assistance device pool. The assistance device pool may be configured and managed by an operator device providing a wireless communication service to which the UE is subscribed.

According to an embodiment, the assistance device pool may include at least one wireless device subscribed to by the same subscriber as the UE, or at least one wireless device subscribed to by a subscriber group including the subscriber. Alternatively, the wireless devices subscribed to by a subscriber group composed of one or more subscribers may be configured as an assistance device pool.

In this case, a separate subscriber ID or subscriber group ID may be allocated to each of the wireless devices constituting the assistance device pool. In other words, when the assistance devices are configured as an assistance device pool, a subscriber ID or subscriber group ID may be allocated and managed by the operator.

According to another embodiment, the assistance device pool may include at least one wireless device supporting an assistance device function capable of operating as an assistance device in any of the plurality of assistance modes. In this case, regardless of the subscriber's UE, the wireless devices capable of operating as assistance devices may be configured as a common assistance device pool independent of the subscriber. In other words, when any subscriber UE has an assistance device function or allows/activates use as an assistance device, the UE may be included in and managed by the common assistance device pool under control of the operator node or base station.

According to an embodiment, the assistance device pool may be configured and managed per cell by the base station. Alternatively, the assistance device pool may be configured and managed on a tracking area basis or on a cell group basis by a mobility control management entity in the core network such as a mobility management entity (MME).

The controller 1610 may receive information about the assistance device pool from the base station. According to one example, the information about the assistance device pool may be received through higher layer signaling, such as RRC signaling.

According to an embodiment, the controller 1610 may receive information about an assistance device set including at least one assistance device selected from the assistance device pool from the base station. The base station may configure an assistance device set from the assistance device pool to enhance wireless quality for a UE in a cell. The assistance device set for the UE may include wireless devices capable of operating as assistance devices among the wireless devices included in the assistance device pool when the assistance device set is configured.

According to an embodiment, the assistance device set may include wireless devices that have transmitted a response to an assistance request requesting for operating as an assistance device, among at least one wireless device included in the assistance device pool. In other words, when the base station intends to perform communication according to an assistance mode, the base station may transmit an assistance request message to the wireless devices belonging to the assistance device pool. The wireless devices that transmits a response message approving the assistance request message may be configured as the assistance device set.

The wireless devices in the assistance device set for the UE configured as described above may be utilized as candidate devices for selecting an assistance device and assistance mode for the UE, and as a target device group or set for direct link state information feedback with the UE. In this case, an assistance device set ID and a device ID within the assistance device set may be allocated to each of the assistance devices included in the assistance device set.

Alternatively, according to another embodiment, a separate assistance device set may not be configured, and all wireless devices belonging to the assistance device pool in the cell to which the UE belongs may be regarded as assistance devices included in the assistance device set. Accordingly, all wireless devices in the assistance device pool may be utilized as candidate devices for selecting an assistance device and assistance mode for the UE, and as an assistance device set that is a target for direct link state information feedback with the UE.

According to an embodiment, the controller 1610 may receive information about the assistance device set through higher layer signaling such as RRC signaling. Alternatively, the information about the assistance device set may be indicated by downlink control information.

The controller 1610 may receive information about an assistance mode selected from among a plurality of assistance modes utilizing the assistance device set for wireless communication with the base station. According to an embodiment, the plurality of assistance modes may include a first assistance mode utilizing only a wireless link with the assistance device set, and a second assistance mode utilizing both a wireless link with the base station and a wireless link with the assistance device set.

The first assistance mode refers to a route selection type assistance mode as an operation method for enhancing wireless quality for the UE. According to the first assistance mode, when it is determined that wireless quality through a relayed wireless link via an assistance device is superior to wireless quality through a wireless link directly connected to the base station, an optimal assistance device may be selected and a link with the UE may be established in a relay manner.

The second assistance mode refers to a cooperative transmission type assistance mode as an operation method for enhancing wireless quality for the UE. According to the second assistance mode, wireless connectivity for the UE may be extended through a plurality of wireless links by establishing an additional wireless link via a relayed link through an assistance device in addition to a direct wireless link (i.e., Uu interface) between the base station and the UE. In this case, the second assistance mode may include i) a first sub mode in which the wireless link with the base station and the wireless link with the assistance device set are configured in different frequency bands, ii) a second sub mode in which the wireless link with the base station and the wireless link with the assistance device set are configured in the same frequency band, and iii) a third sub mode in which the wireless link with the base station and the wireless link with the assistance device set are configured with different radio access technologies (RAT).

In the case of the first sub mode of the second assistance mode, the wireless link with the base station and the wireless link with the assistance device at the UE may be configured to operate in different frequency bands. In this case, the two different frequency bands may be aggregated and used in a carrier aggregation (CA) or dual connectivity (DC) manner.

In the case of the second sub mode of the second assistance mode, the wireless link with the base station and the wireless link with the assistance device at the UE may be configured to operate in the same frequency band. The controller 1610 may perform transmission/reception through the wireless link with the base station and the wireless link with the assistance device separately in at least one of a spatial domain, a frequency domain, or a time domain.

In the case of the third sub mode of the second assistance mode, the wireless link with the base station and the wireless link with the assistance device at the UE may be configured through different radio access technologies. In other words, the direct link between the assistance device and the UE may not be established based on cellular sidelink (i.e., PC5 interface based) but may be established through another RAT such as Wi-Fi, Bluetooth, etc. The controller 1610 may aggregate the wireless link with the base station and the wireless link with the assistance device by means of a multipath TCP (MPTCP) protocol.

Although the disclosure describes the second assistance mode being configured by establishing one additional wireless link through one assistance device in addition to the wireless link between the base station and the UE, it is not limited thereto. The technical spirit of the disclosure may be equally applied to all cases in which cooperative communication is performed by configuring a plurality of additional wireless links through two or more assistance devices. Further, the frequencies where the above-described wireless links operate may each include not only one component carrier (CC) but also a plurality of CCs.

According to an embodiment, the assistance mode to be used for wireless communication may be selected based on channel state information for a wireless link between the UE and each of at least one wireless device included in the assistance device pool or the assistance device set. To that end, the controller 1610 may report direct link channel state information with a wireless device belonging to the assistance device pool or assistance device set configured for the UE to the base station. The direct link channel state information may include operating frequency information of the PC5 link for configuration of the direct link, maximum bandwidth information, maximum transmission rate, capacity information, or CQI/RI information, or the like. Alternatively, to support the third sub mode of the second assistance mode, RAT information for direct link connection may be additionally included.

The base station may select an appropriate assistance mode based on the channel state reporting information of the UE. The base station may transmit information about the selected assistance mode to each of the UE and the assistance device. The information about the selected assistance mode may further include direct link configuration information between the assistance device and the UE.

The controller 1610 may perform wireless communication through at least one of the wireless link with the base station or the wireless link with the assistance device set based on the information about the selected assistance mode. According to an embodiment, the controller 1610 may receive i) Uu link scheduling information between the base station and the UE, ii) Uu link scheduling information between the base station and the assistance device for cooperative communication, and iii) PC5 link scheduling control information between the assistance device and the UE from the base station through one scheduling control information according to the selected assistance mode.

Alternatively, according to another embodiment, the controller 1610 may receive the Uu link scheduling information and the PC5 link scheduling control information from the base station through separate scheduling control information (or information message), respectively. In particular, when one scheduling control information is used, group ID information such as group-C-RNTI information may be further included in the information about the assistance mode for both the assistance device and the UE to receive the scheduling control information.

According to the embodiments described above, wireless communication may be performed between the UE and the base station with enhanced wireless connectivity.

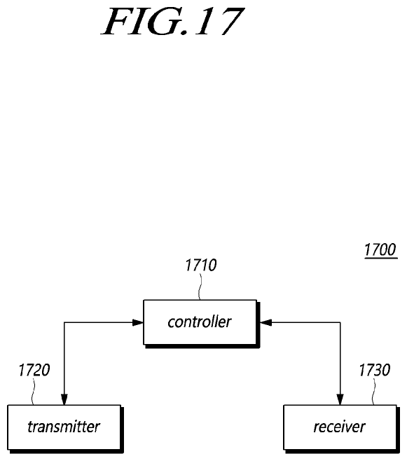

FIG. 17 is a block diagram illustrating a base station 1700 according to an embodiment.

Referring to FIG. 17, a base station 1700 according to an embodiment includes a transmitter 1720, a receiver 1730, and a controller 1710 controlling operations of the transmitter and the receiver.

The controller 1710 controls overall operations of the base station 1700 according to a method for performing wireless communication with enhanced wireless connectivity necessary for performing the embodiments described above. The controller 1710 may be configured to transmit information about an assistance device set including at least one assistance device selected from an assistance device pool, transmit information about an assistance mode selected from among a plurality of assistance modes utilizing the assistance device set for wireless communication with the UE, and perform wireless communication through at least one of a wireless link with the UE or a wireless link with the assistance device set based on the information about the selected assistance mode.

According to an embodiment, the assistance device pool may include at least one wireless device subscribed to by the same subscriber as the UE, or at least one wireless device subscribed to by a subscriber group including the subscriber.

Alternatively, the wireless devices subscribed to by a subscriber group composed of one or more subscribers may be configured as an assistance device pool.

In this case, a separate subscriber ID or subscriber group ID may be allocated to each of the wireless devices constituting the assistance device pool. In other words, when the assistance devices are configured as an assistance device pool, a subscriber ID or subscriber group ID may be allocated and managed by the operator.

According to another embodiment, the assistance device pool may include at least one wireless device supporting an assistance device function capable of operating as an assistance device in any of the plurality of assistance modes. In this case, regardless of the subscriber's UE, the wireless devices capable of operating as assistance devices may be configured as a common assistance device pool independent of the subscriber. In other words, when any subscriber UE has an assistance device function or allows/activates use as an assistance device, the UE may be included in and managed by the common assistance device pool under control of the operator node or base station.

According to an embodiment, the controller 1710 may configure and manage the assistance device pool per cell. Alternatively, the assistance device pool may be configured and managed on a tracking area basis or on a cell group basis by a mobility control management entity in the core network such as a mobility management entity (MME).

The controller 1710 may transmit information about the assistance device pool to the UE. According to an embodiment, the information about the assistance device pool may be transmitted through higher layer signaling such as RRC signaling.

According to an embodiment, the controller 1710 may transmit information about an assistance device set including at least one assistance device selected from the assistance device pool to the UE.

The controller 1710 may configure an assistance device set from the assistance device pool to enhance wireless quality for a UE in a cell. The assistance device set for the UE may include wireless devices capable of operating as assistance devices among the wireless devices included in the assistance device pool when the assistance device set is configured.

According to an embodiment, the assistance device set may include wireless devices that transmitted a response to an assistance request requesting operation as an assistance device, among at least one wireless device included in the assistance device pool. In other words, when the controller 1710 intends to perform communication according to an assistance mode, the controller 1710 may transmit an assistance request message to the wireless devices belonging to the assistance device pool. The wireless devices that transmit a response message approving the assistance request message may be configured as the assistance device set.

In this case, an assistance device set ID and a device ID within the assistance device set may be allocated to each assistance device included in the assistance device set.

Alternatively, according to another embodiment, a separate assistance device set may not be configured, and all wireless devices belonging to the assistance device pool in the cell to which the UE belongs may be regarded as assistance devices included in the assistance device set. Accordingly, all wireless devices in the assistance device pool may be utilized as candidate devices for selecting an assistance device and assistance mode for the UE, and as an assistance device set that is a target for direct link channel state information feedback with the UE.

According to an embodiment, the controller 1710 may transmit information about the assistance device set through higher layer signaling such as RRC signaling. Alternatively, the controller 1710 may indicate information about the assistance device set through downlink control information.

The controller 1710 may transmit information about an assistance mode selected from among a plurality of assistance modes utilizing the assistance device set for wireless communication with the UE. According to an embodiment, the plurality of assistance modes may include a first assistance mode utilizing only a wireless link with the assistance device set and a second assistance mode utilizing both a wireless link with the base station and a wireless link with the assistance device set.

The first assistance mode refers to a route selection type assistance mode that operates to enhance wireless quality for the UE. According to the first assistance mode, when it is determined that wireless quality through a relayed wireless link via an assistance device is superior to wireless quality through a wireless link directly connected to the base station, an optimal assistance device may be selected and a link with the UE may be established in a relay manner.

The second assistance mode refers to a cooperative transmission type assistance mode as an operation method for enhancing wireless quality for the UE. According to the second assistance mode, wireless connectivity for the UE may be extended through a plurality of wireless links by establishing an additional wireless link through a relayed link via an assistance device in addition to a direct wireless link (i.e., Uu interface) between the base station and the UE.

In this case, the second assistance mode may include a first sub mode in which the wireless link with the base station and the wireless link with the assistance device set are configured in different frequency bands, a second sub mode in which the wireless link with the base station and the wireless link with the assistance device set are configured in the same frequency band, and a third sub mode in which the wireless link with the base station and the wireless link with the assistance device set are configured with different radio access technologies (RAT).

In the case of the first sub mode of the second assistance mode, the wireless link with the base station and the wireless link with the assistance device at the UE may be configured to operate in different frequency bands. In this case, the two different frequency bands may be aggregated and utilized in a carrier aggregation (CA) or dual connectivity (DC) manner.

In the case of the second sub mode of the second assistance mode, the wireless link with the base station and the wireless link with the assistance device at the UE may be configured to operate in the same frequency band. The UE may perform transmission/reception through the wireless link with the base station and the wireless link with the assistance device separately in at least one of a spatial domain, a frequency domain, or a time domain.

In the case of the third sub mode of the second assistance mode, the wireless link with the base station and the wireless link with the assistance device at the UE may be configured through different radio access technologies. In other words, the direct link between the assistance device and the UE may not be established based on cellular sidelink (i.e., PC5 interface based) but may be established through another RAT such as Wi-Fi, Bluetooth, or the like. The UE may aggregate the wireless link with the base station and the wireless link with the assistance device by means of a multipath TCP (MPTCP) protocol.

According to an embodiment, the assistance mode to be used for wireless communication may be selected based on channel state information for a wireless link between the UE and each of at least one wireless device included in the assistance device pool or the assistance device set. To that end, the controller 1710 may receive direct link channel state information with a wireless device belonging to the assistance device pool or assistance device set configured for the UE from the UE. The direct link channel state information may include operating frequency information of the PC5 link for configuration of the direct link, maximum bandwidth information, maximum transmission rate, capacity information, CQI/RI information, or the like. Alternatively, for support of the third sub mode of the second assistance mode, RAT information for direct link connection, etc. may also be included.

The controller 1710 may select an appropriate assistance mode based on the channel state reporting information of the UE. The controller 1710 may then transmit information about the selected assistance mode to each of the UE and the assistance device. The information about the selected assistance mode may further include direct link configuration information between the assistance device and the UE.

The controller 1710 may perform wireless communication through at least one of the wireless link with the UE and the wireless link with the assistance device set based on the information about the selected assistance mode. According to an embodiment, the controller 1710 may transmit i) Uu link scheduling information between the base station and the UE, ii) Uu link scheduling information between the base station and the assistance device for cooperative communication, and iii) PC5 link scheduling control information between the assistance device and the UE to the UE through single scheduling control information (e.g., information message) according to the selected assistance mode.

Alternatively, according to another embodiment, the controller 1710 may transmit the Uu link scheduling information and the PC5 link scheduling control information to the UE through separate scheduling control information, respectively. In particular, when single scheduling control information is used, group ID information, such as group-C-RNTI information or the like, may be further included in the information about the assistance mode for both the assistance device and the UE to receive the scheduling control information.

According to the embodiment described above, wireless communication may be performed between the UE and the base station with enhanced wireless connectivity.

The embodiments described above may be supported by the standard documents disclosed in at least one of the radio access systems such as IEEE 802, 3GPP, and 3GPP2. That is, the steps, configurations, and parts, which have not been described in the present embodiments, may be supported by the above-mentioned standard documents for clarifying the technical concept of the disclosure. In addition, all terms disclosed herein may be described by the standard documents set forth above.

The above-described embodiments may be implemented by any of various means. For example, the present embodiments may be implemented as hardware, firmware, software, or a combination thereof.

In the case of implementation by hardware, the method according to the present embodiments may be implemented as at least one of an application specific integrated circuit (ASIC), a digital signal processor (DSP), a digital signal processing device (DSPD), a programmable logic device (PLD), a field programmable gate array (FPGA), a processor, a controller, a microcontroller, or a microprocessor.

In the case of implementation by firmware or software, the method according to the present embodiments may be implemented in the form of an apparatus, a procedure, or a function for performing the functions or operations described above. Software code may be stored in a memory unit, and may be driven by the processor. The memory unit may be provided inside or outside the processor, and may exchange data with the processor by any of various well-known means.

In addition, the terms “system”, “processor”, “controller”, “component”, “module”, “interface”, “model”, “unit”, and the like may generally mean computer-related entity hardware, a combination of hardware and software, software, or running software. For example, the above-described components may be, but are not limited to, a process driven by a processor, a processor, a controller, a control processor, an entity, an execution thread, a program and/or a computer. For example, both the application that is running in a controller or a processor and the controller or the processor may be components. One or more components may be provided in a process and/or an execution thread, and the components may be provided in a single device (e.g., a system, a computing device, etc.), or may be distributed over two or more devices.

The above embodiments of the present disclosure have been described only for illustrative purposes, and those skilled in the art will appreciate that various modifications and changes may be made thereto without departing from the scope and spirit of the disclosure. Further, the embodiments of the disclosure are not intended to limit, but are intended to illustrate the technical idea of the disclosure, and therefore the scope of the technical idea of the disclosure is not limited by these embodiments. The scope of the present disclosure shall be construed on the basis of the accompanying claims in such a manner that all of the technical ideas included within the scope equivalent to the claims belong to the present disclosure.

### CROSS-REFERENCE TO RELATED APPLICATION

This application claims the benefit of priority under 35 U.S.C. § 119 (a) to Korean Patent Application No. 10-2023-0060740, filed in Korea on May 10, 2023, the entire disclosure of which is incorporated herein by reference. Furthermore, this application claims priority to applications filed in countries other than the United States for the same reasons as set forth above, and the entire 5 disclosures thereof are also incorporated herein by reference.

1. A method for a user equipment (UE) to perform wireless communication, the method comprising:
receiving information about an assistance device set including at least one assistance device selected from an assistance device pool;
receiving information about an assistance mode selected from a plurality of assistance modes utilizing the assistance device set for wireless communication with a base station; and
performing wireless communication through at least one of a wireless link with the base station or a wireless link with the assistance device set based on the information about the selected assistance mode.

2. The method of claim 1, wherein the assistance device pool includes at least one wireless device subscribed to by a subscriber of the UE or at least one wireless device subscribed to by a subscriber group including the subscriber.

3. The method of claim 1, wherein the assistance device pool includes at least one wireless device supporting an assistance device function capable of operating as an assistance device in any of the plurality of assistance modes.

4. The method of claim 1, wherein the assistance device set includes wireless devices that transmitted a response to an assistance request for operating as an assistance device, among at least one wireless device included in the assistance device pool.

5. The method of claim 1, wherein the selected assistance mode is selected based on channel state information for a wireless link between the UE and each wireless device included in the assistance device pool or the assistance device set.

6. The method of claim 1, wherein the plurality of assistance modes include a first assistance mode utilizing only a wireless link with the assistance device set and a second assistance mode utilizing both a wireless link with the base station and a wireless link with the assistance device set.

7. The method of claim 6, wherein the second assistance mode includes i) a first sub mode in which the wireless link with the base station and the wireless link with the assistance device set are configured in different frequency bands, ii) a second sub mode in which the wireless link with the base station and the wireless link with the assistance device set are configured in the same frequency band, and iii) a third sub mode in which the wireless link with the base station and the wireless link with the assistance device set are configured with different radio access technologies.

8. A method for a base station to perform wireless communication, the method comprising:
transmitting information about an assistance device set including at least one assistance device selected from an assistance device pool;
transmitting information about an assistance mode selected from a plurality of assistance modes utilizing the assistance device set for wireless communication with a user equipment (UE); and
performing wireless communication through at least one of a wireless link with the UE or a wireless link with the assistance device set based on the information about the selected assistance mode.

9. The method of claim 8, wherein the assistance device pool includes at least one wireless device subscribed to by a subscriber of the UE or at least one wireless device subscribed to by a subscriber group including the subscriber.

10. The method of claim 8, wherein the assistance device pool includes at least one wireless device supporting an assistance device function capable of operating as an assistance device in the plurality of assistance modes.

11. The method of claim 8, wherein the assistance device set includes wireless devices that transmitted a response to an assistance request for operating as an assistance device, among at least one wireless device included in the assistance device pool.

12. The method of claim 8, wherein the selected assistance mode is selected based on channel state information for a wireless link between the UE and each wireless device included in the assistance device pool or the assistance device set.

13. The method of claim 8, wherein the plurality of assistance modes include a first assistance mode utilizing only a wireless link with the assistance device set and a second assistance mode utilizing both a wireless link with the UE and a wireless link with the assistance device set.

14. The method of claim 13, wherein the second assistance mode includes i) a first sub mode in which the wireless link with the base station and the wireless link with the assistance device set are configured in different frequency bands, ii) a second sub mode in which the wireless link with the base station and the wireless link with the assistance device set are configured in the same frequency band, and iii) a third sub mode in which the wireless link with the base station and the wireless link with the assistance device set are configured with different radio access technologies.

15. A user equipment (UE) performing wireless communication, the UE comprising:
a transmitter;
a receiver; and
a controller controlling an operation of the transmitter and the receiver,
wherein the controller is configured to receive information about an assistance device set including at least one assistance device selected from an assistance device pool, receive information about an assistance mode selected from among a plurality of assistance modes utilizing the assistance device set for wireless communication with a base station, and perform wireless communication through at least one of a wireless link with the base station or a wireless link with the assistance device set based on the information about the selected assistance mode.

16. The UE of claim 15, wherein the selected assistance mode is selected based on channel state information for a wireless link between the UE and each of at least one wireless device included in the assistance device pool or the assistance device set.

17. The UE of claim 15, wherein the plurality of assistance modes include a first assistance mode utilizing only a wireless link with the assistance device set and a second assistance mode utilizing both a wireless link with the base station and a wireless link with the assistance device set.
